(19) United States
(12) Patent Application Publication
(10) Pub. No.: US 2001/0020826 A1
(43) Pub. Date: Sep. 13, 2001

(54) Starting device for discharge lamp

(76) Inventor: Osamu Miyata, Tokyo (JP)

Correspondence Address: Douglas W. Sprinkle, Gifford, Krass, Sprinkle, Anderson, Citkowski, P.C., 280 N. Old Woodward, Suite 400, Birmingham, MI, 48009, US

(21) Appl. No.: 09/778,656

(22) Filed: Feb. 7, 2001

(30) Foreign Application Priority Data
Mar. 10, 2000 (JP) 2000-066435

(51) Int. Cl. H01K 1/62; H01J 7/44; H01J 13/46; H01J 17/34; H01J 19/78

(52) U.S. Cl. 315/57; 315/248; 315/254

(57) ABSTRACT

The objectives of the present invention are to provide a smaller, lighter and less expensive structure in a starting device for discharge lamp for car use so as to prevent breakage due to vibrations etc.. The starting device for discharge lamp comprising; a socket for mounting the discharge lamp, a bobbin and a starting transformer having a core-less structure equipped with a primary and a secondary coils wound around the bobbin; wherein the starting transformer is formed as in a ring or a horseshoe. A bobbin with a straight bar shape which enables the starting transformer to be arranged laterally is other alternative.

### BACKGROUND OF THE INVENTION 1. Field of the Invention

The present invention relates to a starting device for discharge lamp, particularly suitable to a lamp lighting device for vehicle headlights.

2. Brief Description of the Prior Art

The Lamp lighting device for vehicle headlights having a starting transformer equipped with a core is now widely used. In order to avoid an electric current saturation phenomenon that sometimes occurs in the starting transformer equipped with the above-mentioned core, a volume of the core has to be increased. In other words, inductance value in the ordinary transformer, usually equipped with the core, reaches a saturated value (corresponding to the inductance value of a core-less transformer), at a certain electric current value, as shown in FIG. 8 where inductance characteristic curves against electric current value are depicted.

Magnetic properties of the core are influenced by ambient temperature. FIG. 9 depicts relations between initial permeability (μi) of A type and B type cores used at a relatively lower temperature (below 100° C.) and at a relatively higher temperature (below 150° C.) respectively, and temperature T (° C.) so as to determine Curie temperatures in the respective core types.

The Curie temperature of A type is 174° C. for a lower temperature use and that of B type is 200° C. for a higher temperature use. Since a ferrite core has a critical temperature (Curie temperature) where the core transforms from ferromagnetic to paramagnetic, the ferrite core with the higher Curie temperature should be used at a higher temperature range (100° C.-200° C.).

When an HID lamp is employed as the discharge lamp, the core with Curie temperature above 200° C. should be selected for the starting transformer from a safety point, since heat from the lamp raises the temperature of the core up to ca. 150° C. when a starting circuit is arranged in a lamp socket due to a short distance between the lamp and the core. The higher Curie temperature of the core is, the lower an initial permeability (μi) of the core is (i.e. a lower inductance value when coil turns are kept constant), which means lower performance. Usually such core is not employed so that quantity of the commercially manufactured core is few, which naturally results in a cost increase.

When ferrite type cores are molded by an epoxy resin etc. for insulation, fatal defects such as ruptures or cracks are sometimes formed due to a shrinkage difference between the core and the molded resin. In order to avoid the above-mentioned defects caused by the shrinkage of the molded resin, the core has to be closed in a bobbin etc. or the core with a simple shape (round or rectangular rod etc.) has to be employed.

In the conventional starting device for discharge lamp with the above-mentioned core, a supporting point of the core was easily broken by vibrations and impacts etc. because of a core weight. As measures against such breakage a core supporting mechanism was reinforced or other supporting members were added. Which resulted in a manufacturing cost increase.

### SUMMARY OF THE INVENTION

The present invention is carried out in view of the above-mentioned problems so as to provide a small sized and light weighed device free from breakage due to vibrations and impacts and to provide a less expensively constituted device.

The starting device for discharge lamp is constituted as follows:

(1) The starting device for discharge lamp comprising; a socket equipped with a high voltage electrode and a grounding electrode for mounting the discharge lamp, a bobbin and a starting transformer having a core-less structure equipped with a primary and a secondary coils wound around the bobbin; wherein the starting transformer is formed in a ring shape.

(2) The starting device for discharge lamp comprising; a socket equipped with a high voltage electrode and a grounding electrode for mounting the discharge lamp, a bobbin and a starting transformer having a core-less structure equipped with a primary and secondary coils wound around a bobbin; wherein the starting transformer is formed in a horseshoe shape.

(3) The starting device for discharge lamp comprising; a socket equipped with a high voltage electrode and a grounding electrode for mounting the discharge lamp, a bobbin and a starting transformer having a core-less structure equipped with a primary and secondary coils wound around a bobbin; wherein the starting transformer is formed in a straight bar shape for being arranged laterally.

(4) The starting device for discharge lamp according to (1) or (2) where the core-less structure with 0 to 10 mm in diameter formed in a round shape, coil winding portion of the bobbin is formed in a divided round shape for divided winding and arranged on the same axis of the socket, and further a leading wire from the secondary coil is electrically connected to a high voltage electrode of the socket after the leading wire is led through the center of the socket.

(5) The starting device for discharge lamp according to either one of (1) to (4) where the device is equipped with a harness with connector.

(6) The starting device for discharge lamp according to either one of (1) to (4) where the device is equipped with a direct coupler.

### BRIEF DESCRIPTION OF DRAWINGS

FIGS. 1A and 1B show a constitution of a first embodiment according to the present invention. FIG. 1A is a front view. FIG. 1B is a side view.

FIG. 2A is a cross sectional view along A-A line in FIG. 1A. FIG. 2B is a rear view with rear socket cover removed, where a harness equipped with a connector is arranged.

FIGS. 3A to 3D show a constitution of a second embodiment according to the present invention. FIG. 3A is a front view. FIG. 3B is a side view. FIG. 3C is a cross sectional view along B-B line in FIG. 3A. FIG. 3D is a rear view with rear socket cover removed, where a direct coupler is arranged.

FIGS. 4A and 4B show a first coil arrangement of the starting transformer in the embodiments. FIG. 4A is a plan view. FIG. 4B is a cross sectional view along C-D-E line in FIG. 4A.

FIGS. 5A to 5C show a second coil arrangement of the starting transformer in the embodiments. FIG. 5A is a plan view. FIG. 5B is a cross sectional view along F-F line in FIG. 5A. FIG. 5C is a side view.

FIGS. 6A to 6E show a third coil arrangement of the starting transformer in the embodiments. FIG. 6A is a plan view. FIG. 6B is a cross sectional view along G-G line in FIG. 6A. FIG. 6C is a side view viewed from a primary coil side. FIG. 6D is a side view viewed from a secondary coil side. FIG. 6E is a side view.

FIG. 7 shows a starting circuit diagram.

FIG. 8 depicts inductance characteristic curves against electric current of starting transformers with/without core.

FIG. 9 depicts initial permeability curves of ferrite cores against temperature (Curie point determination curve).

FIG. 10 depicts HID lamp intensity curves against duration in relation to pulse widths.

FIGS. 11A and 11B show transient curves of starting pulses. FIG. 11A shows a curve of the present embodiments. FIG. 11B shows a curve of the conventional starting device.

### DETAILED DESCRIPTION OF THE PREFERRED EMBODIMENTS

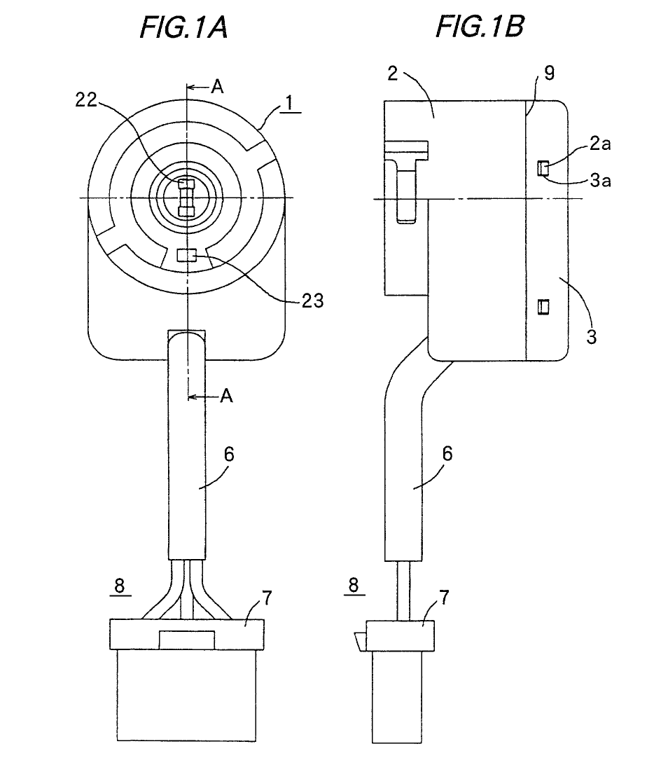

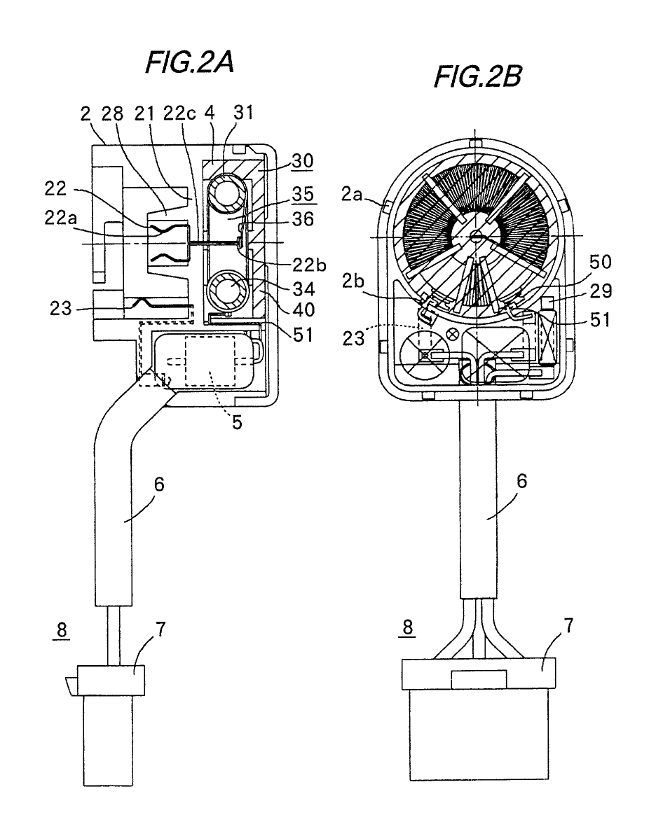

The first embodiment according to the present invention shown in FIGS. 1A to 1B and FIGS. 2A to 2B is explained. This embodiment relates to a starting device for lamp lighting equipped in a lamp lighting device for an HID lamp. The lamp lighting device includes power sources for the HID lamp and for a trigger element to generate a starting pulse etc. equipped in a main body (not shown) of the lamp lighting device. The starting device for lamp lighting consists of structural members such as parts for starting, an HID lamp socket etc.. The main body of the lamp lighting device and the starting device for lamp lighting is electrically connected via a harness 6 and a connector 7 equipped to the starting device for lamp lighting, to a direct coupler equipped to the main body of the lightning device.

FIG. 1A is a front view of a starting device 1 for lamp lighting for car use where a front socket case 2, a left side portion of a parting line 9 (see FIG. 1B), has a high voltage electrode 22 and a GND (grounding) electrode 23 formed by an insert molding or a direct insertion. FIG. 1B is a side view illustrating how 7 protruded portions 2a (quantity varies case by case) formed on the socket case 2 are fitted in cutout openings 3a formed on a rear socket case 3.

Hereinafter an inside arrangement of a socket 20 constituted in the above-mentioned way is explained by referring FIG. 2A, a cross sectional view of along A-A line in FIG. 1A, FIG. 2B, a rear view with a socket case 3 removed. An insulating wall 28 is formed in the socket for insulating between the high voltage electrode 22 and the GND electrode 23, since a voltage between them reaches up to 20-odd kV. A high voltage leading electrode 22c (see FIG. 2A) led out from a high voltage lamp mounting electrodes 22a of the high voltage electrode 22 surrounded by the insulating wall 28, comprises a rear portion of the high voltage electrode 22. The high voltage leading electrode 22c has a circular cross sectional area with diameter of 0.1 to 10 mm or a corresponding square cross sectional area with diameter of 0.1 to 8 mm square, so as to withstand the maximum current 2.6 A for the HID lamp. The high voltage leading electrode 22c extends thorough a separating wall 21 of the socket to a starting transformer accommodating space 4, further extends through the center of the starting transformer 30, i.e. a hollow ring center 35. And finally the high voltage leading electrode 22c is connected to a leading wire 36 at a high voltage side of a secondary coil 32 (which is explained below) via a high voltage electrode 22b, one end of the electrode 22c at the starting transformer side.

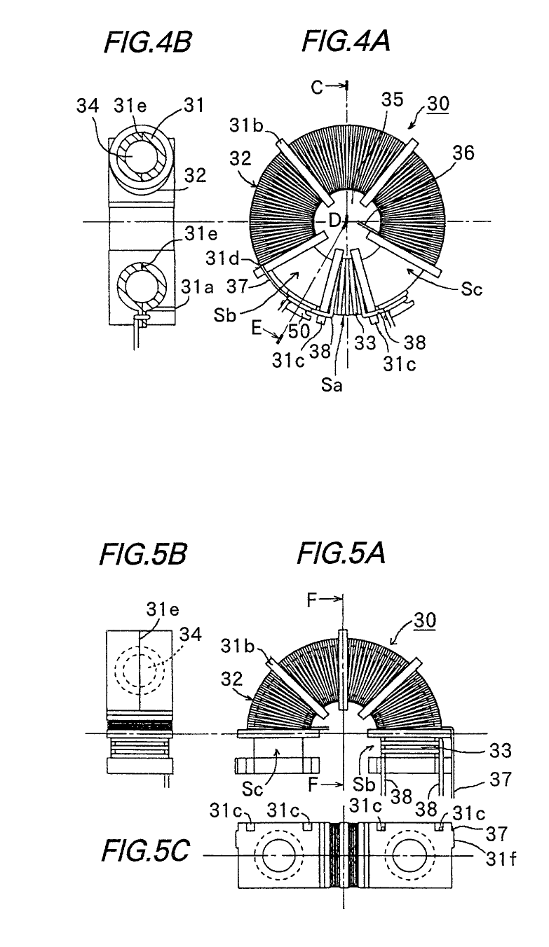

The starting transformer 30 consists of the bobbin 31 and the secondary coil 32 evenly wound around each winding section as shown in FIG. 4A. The secondary coil 32 is wound 100 to 400 turns with 0.1 to 1.0 mm wire in diameter. In experiments 300 turns and 0.3 mm in diameter are employed, where the distributed capacity is ca. 3 pF. The bobbin shows a ring shape in accordance with geometry of the socket. The bobbin is formed as the ring having a hollow cross section or a solid cross section by sticking two parts, i.e. two halves of the ring divided by a plane parallel to the ring, together. Coil winding portions with a circular cross section are employed from a point of winding efficiency. Winding portions are divided into 3 to 6 sections. A distributed capacity of the secondary coil 32 is increased by divided turns explained above.

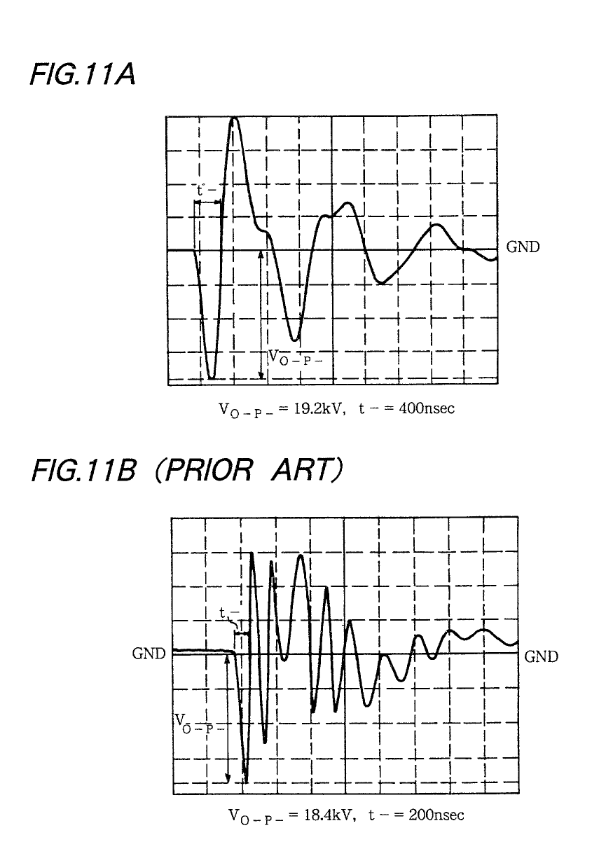

The further apart from a magnetic center (in this case a winding center) is, the more increased the distributed capacity usually is. This capacity is a significant factor to increase a starting pulse width. FIG. 11A shows a typical example of the increased starting pulse where a good vibration wave pattern is attained experimentally.

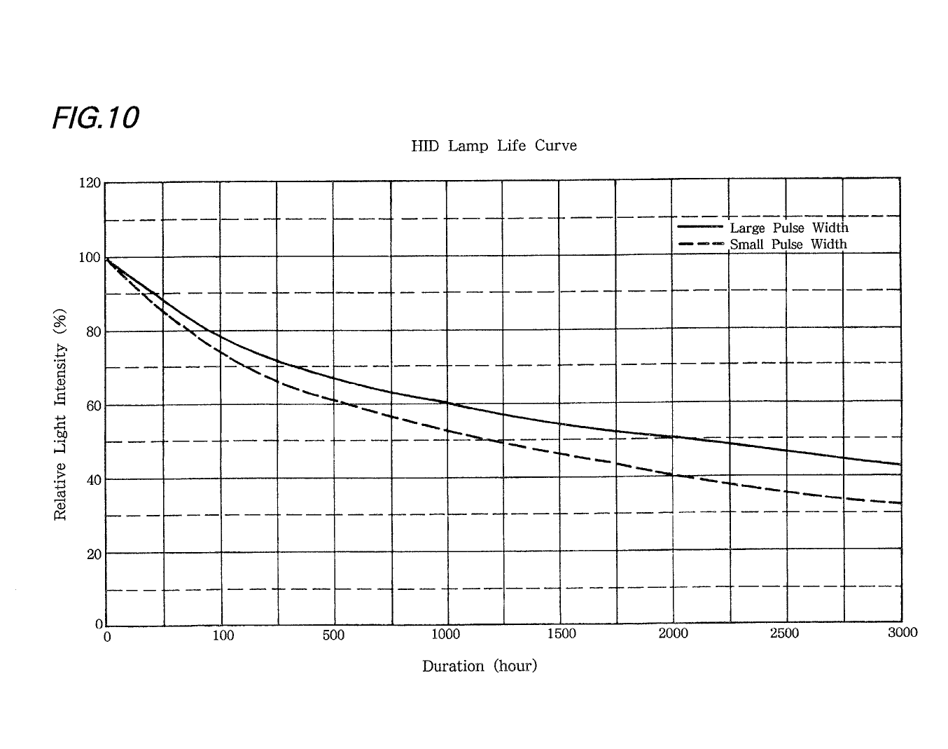

Our experiments proved that the distributed capacity is increased when more turns (overlapping turn) are formed at a narrow winding section so that the starting pulse width is increased, thus a life of an HID lamp is improved, since wearing a HID lamp electrode is suppressed as shown in FIG. 10. HID lamp life curves of a wide starting pulse width (0.4 msec) and of a narrow pulse width (0.2 msec) are plotted in FIG. 10 where an abscissa represents flashing duration of lamps and an ordinate represents relative light intensity. From this figure in case of the wide starting pulse width the light intensity seems to be deteriorated more slowly. A flushing mode of the lamp lighting device for car use in these experiments is as follows—after 5 cycles of ON (9 min. 45 sec.)/OFF (15 sec.), 10 min. OFF—. Since energy of the starting pulse (energy to start HID lamp) is usually determined by a product multiplied by the pulse width and a peak value of starting pulse voltage, the peak value can be decreased (to around limited value 20 kV) by increasing the pulse width. Namely, a boosted voltage ratio (turning number of primary coil/turning number of secondary coil) is kept lower. As a result advantages such as obtaining a small sized transformer and an efficient transformer with less copper loss are attained by decreased turning number of the secondary coil.

The distributed capacity of the secondary coil with one rowed non-divided turn is ca. 0.001 pF, on condition that the turning number is kept constant. In the case of this distributed capacity, the starting pulse width is ca. 0.2 μsec and shows a steep starting curve. (See FIG. 11A and 11B.)

On the bobbin 31 a wire with a circular cross section is wound in stead of a wire with a rectangular cross section considering a winding efficiency. (The wire with the circular section has the lowest copper loss when a cross sectional area and the number of the turn are kept constant due to the fact that the outer diameter of the wire, namely, a length of the wound wire amounts to the shortest.) A width of each divided section (3 to 30 mm at the inner diameter of the ring) of the bobbin 31 is set several (an integer) times of the outer diameter of the wire so as to attain the most efficient winding. A wall thickness between the sections is set 0.5 to 2.0 mm. The primary coil 33 (1 to 10 turns, 0.1 to 1.0 in diameter. In our experiments a 4 turned coil by a wire having 0.5 mm in diameter is employed.) is arranged either at an intermediate section A (Sa) situated between low voltage and high voltage sides of the secondary coil 32 (See FIG. 4A) or at a low voltage section B (Sb) of the secondary coil 32 considering a voltage difference between the primary and secondary coils. However, when the primary coil 33 is wound around on a high voltage section C (Sc) of the secondary coil 32, a wire with high insulating property (withstand voltage: 10 to 20 kV) such as a wire with three layered insulation has to be used.

A leading wire 37 (see FIG. 4A) at a lower voltage side of the secondary coil 32 and two leading wires 38 of the primary coil 33 are connected to two leading wire connecting points 50 (number is adjustable) formed on the bobbin 31. And these leading wires are lead to parts accommodating compartment 5 for the starting device via two slits 2b (number is adjustable) so as to trail on the side wall of a starting transformer accommodating compartment 4. Parts for a starting circuit accommodated in the parts accommodating compartment 5 for the starting device are connected to a connecting board 29 (See FIG. 2B) connecting the starting transformer to a harness assembly 8, by welding or high temperature soldering. (Since this portion is located near the HID lamp so that the ambient temperature reaches ca. 150° C., a low temperature solder usually employed in organic circuit boards is not suitable.)

The leading wires 37 and 38 are contacted with the starting transformer accommodating compartment 4 closely via a clip 51 in order to avoid these leading wires from contacting the coils (particularly the secondary coil 32, to ensure insulation).

After accommodating the starting transformer in the accommodating compartment 4, only the starting transformer 30 is molded with a molding material 40 (an epoxy resin, a urethane resin, a silicon resin and the like). A good insulation is attained due to a molding material 40 flown into the whole portion of the starting transformer including the central hollow portion 35. Sometimes the parts accommodating compartment 5 for starting device is molded after arranging parts for the starting circuit in it in view of ensured insulation, protection against humidity, vibration and a stable fixture of parts.

The GND electrode 23 is connected to the parts accommodating compartment 5 for the starting device via inner portion of a separating wall 21 of the socket. The electrode is finally connected to the harness assembly 8, which leads to the main body of the starting apparatus via the inputting connector 7.

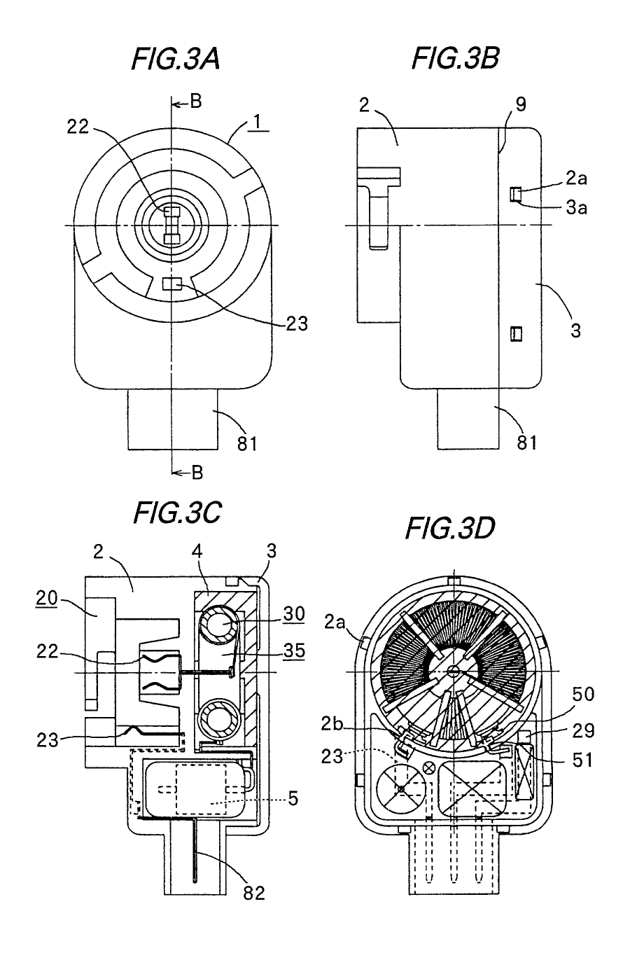

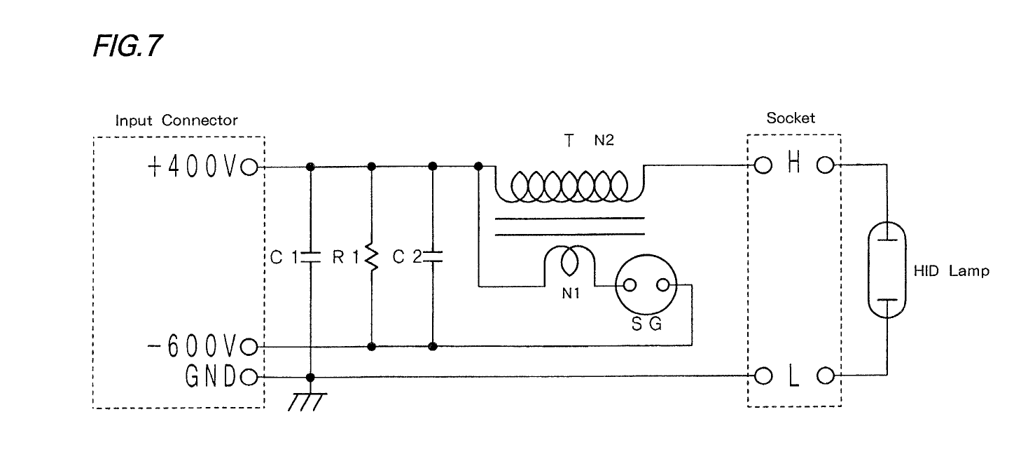

Hereinafter the second embodiment shown in FIGS. 3A to 3D is explained. An electrical connection between the main body of the starting device and starting device for lamp lighting is attained by connecting a direct coupler equipped on the main body of the starting device to a direct coupler 81 equipped on the starting device for lamp lighting, via a harness having a connector (not shown). Input terminals 82 (3 terminals +400V, −600V and GND in FIG. 7) equipped in the direct coupler 81 are metal electrodes formed in one-pieced member (formed in the socket case 2 or 3 by an insert molding) combined with an HID-GND electrode and the GND electrode 23 at a low voltage side of the secondary coil 32 or formed in separated members. Since only this forming method of the metal electrodes is different from those of preceding embodiment 1, further detailed explanation is omitted.

Hereinafter a starting lamp circuit depicted in FIG. 7 is described. Input powers supplied from the main body of the starting device (not shown in the figure) are +400V, GND as main powers and −600V as a power for SG (spark gap), a trigger element for high voltage pulse. In this embodiments the SG having a break down point of 800 kV is selected among SGs for car use having the break down points between 400V and 3 kV. The power −600V is supplied to the starting device circuit via resistance (not shown) connected in series to the output terminal. A constant determining a pulse cycle (usually between 30 to 150 Hz) is determined by applying 1 kV (voltage between the two terminals −600V and 400V) to a circuit where the above-mentioned resistance (not shown) and a charging/discharging capacitor C2 are connected in series.

When a voltage in the capacitor C2 reaches the break down point (In case of the SG of 800V the value is 800V +/−15%.) a electric current starts to flow in a primary coil N1 of the starting transformer T, which induces a high voltage in a secondary coil N2. The induced high voltage generates a starting pulse (ca. 25 kV) at the power +400V, as a result the HID lamp is activated. In these figures C1 is a capacitor used as a filter for the input powers and R1 is a resistance for discharging electric charge stored in the capacitor C2.

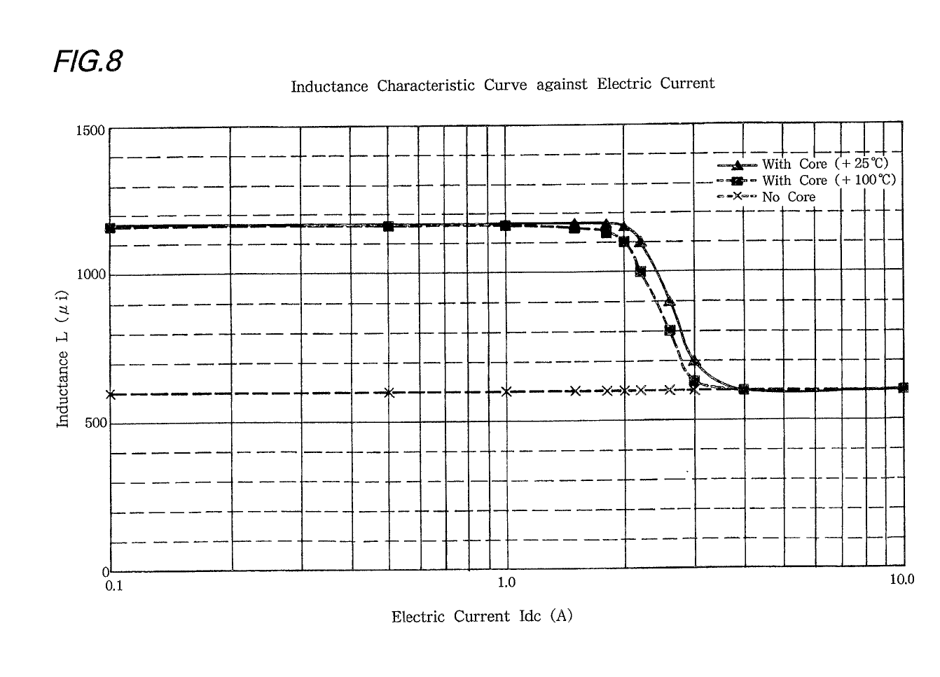

Hereinafter inductance characteristics of coils with core or without core are explained by referring FIG. 8. The figure, where an abscissa is electric current scale and an ordinate is inductance scale, shows that in coils with core inductance value start decreasing from a certain electric current value (in this case 2.0 A) and finally reach a constant value (saturated phenomena), in accordance with increasing electric current. When the ambient temperature is raised (+100° C.) the inductance value reaches the saturated phenomenon at a lower electric current value than that of the ordinary temperature (+25° C.). However in case of a coil without core the inductance keeps a constant value independent from changes of the electric current value and the ambient temperature.

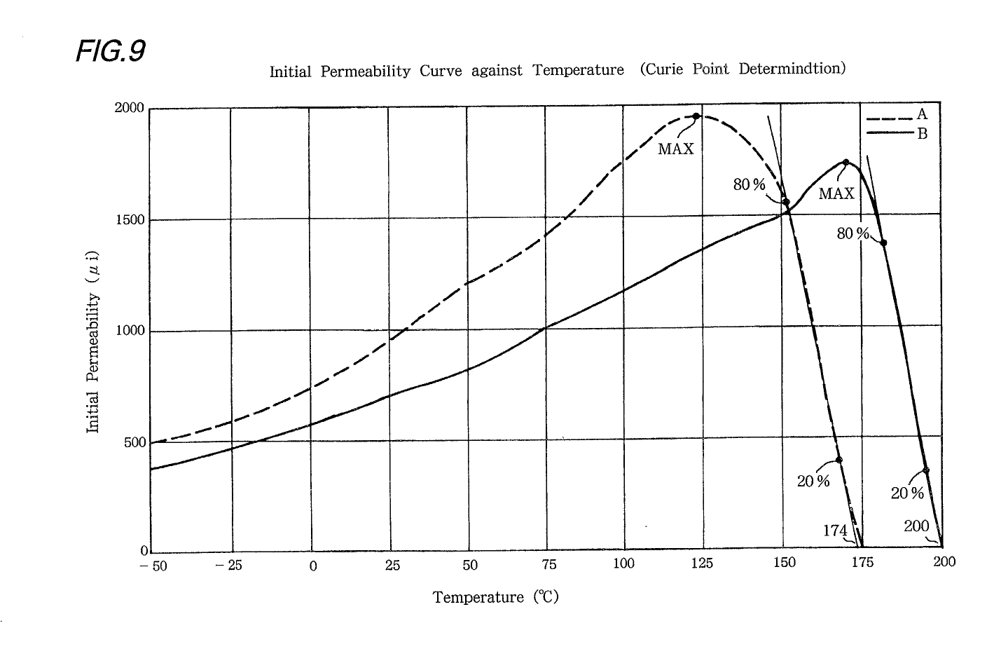

In FIG. 9 initial permeability curves of cores against temperature for determining Curie point are plotted. The figure depicts data of Ni-ferrite cores. A Curie point means a critical temperature where a magnetic property of a core changes from ferromagnetic to paramagnetic. Practically the Curie point is determined as follows: On a declining portion of the initial permeability (μi) curve against increasing temperature, two points, 80% and 20% of the maximum initial permeability, are determined and a line determined by the above-mentioned two points is extrapolated up to a point where μi=1.0, a temperature value at this point is defined as the Curie point.

By the above-mentioned method the Curie point of the A type core is determined 174° C. and that of the B type core is determined 200° C. Considering that the core is employed for car use and is equipped near the HID lamp, a core with higher Curie point is favorable, but μi reciprocally decreases against the increased Curie point as shown in FIG. 9. In other words a coil with more turns are needed to obtain a required inductance value when a core with higher Curie point is used. The coil occupies more space and results in a larger sized starting device. In addition a resistance value in the coil is increased so that a power loss due to the increased resistance value is added to the circuit where the secondary coil N2 of the transformer T is directly connected to the power line +400V as shown in FIG. 7. Which results in decreasing the efficiency of the starting circuit. Since the cores with high Curie points are circulated not so many in the market and usually are not used, producing these cores requires higher cost. The coil with core-less structure employed in the present invention solves above-mentioned problems.

Hereinafter shapes of the starting transformer 30 employed in the above-mentioned embodiments are explained. FIGS. 4A and 4B show the first structure where the starting transformer 30 is formed in the ring shape with a closed magnetic path. The bobbin 31 having the hollow portion 34 (or solid portion filled with the same material as the bobbin, in either case no magnetic substance such as core etc. is arranged) is formed in the ring shape with 6 sectional walls 31b (number is adjustable) in this case. Three sections separated by these sectional walls 31b are allocated for coil winding space of the secondary coil 32 and one section (section A: Sa) is for the coil winding space of the primary coil 33. A round wire is used for winding the bobbin from a point of efficiency. Slits 31a are formed on all sectional walls 31b contacting with sections for the secondary coil 32 for leading trough wires between two sections.

Owing to geometry of the bobbin 31, after forming two portions divided by a dividing position 31e, the portions are stuck together to form the bobbin. The primary coil 33 is arranged at the intermediate section A (Sa) situated between low voltage and high voltage sides of the secondary coil 32 considering the voltage difference between the primary and secondary coils. The primary coil 33 can be arranged at a low voltage section B (Sb) of the secondary coil 32. However, when the primary coil 33 is wound around on a high voltage section C (Sc) of the secondary coil 32, a wire with high insulating property (withstand voltage: 10 to 20 kV) such as a wire with three layered insulation has to be used.

A leading wire 37 at a lower voltage side (see FIG. 4A) of the secondary coil 32 led through a groove 31d for the secondary coil formed one of the separating wall 31b, and two leading wires 38 of the primary coil 33 led through grooves 31c (two positions) for the primary coil are connected to two leading wire connecting points 50 (number is adjustable) formed on the bobbin 31. And these leading wires are led to parts accommodating compartment 5 for the starting device via three slits 2b so as to trail on the side wall of a starting transformer accommodating compartment 4. (see FIG. 2A and FIG. 3C) A leading wire 36 at a higher voltage side of the secondary coil 32 led through the center of the hollow portion 35 of the ring is connected to a high voltage electrode 22b (see FIG. 2A) at the high voltage side of the starting transformer, namely, it is connected to the high voltage electrode 22. After finishing the above-mentioned connections between the starting transformer and a circuit of the device, a molding material 40 is cast so as to cover whole body of the starting transformer 30 (for insulation, anti-vibration and fixture purposes).

FIGS. 5A to 5C show the second coil arrangement of the starting transformer 30 having a horseshoe shape with half open magnetic path. In this arrangement the secondary coil is divided by section walls 31b. A section for the primary coil 33 is arranged a lower voltage side section B (Sb) of the secondary coil 32. As in the case of FIGS. 4A and 4B, the bobbin 31 also consists of two portions divided by a dividing portion 31e. A protruded portion 31f is formed on the separating section wall 31b to support the leading wire 37 at the lower voltage side of the secondary coil 32. By employing this shape a starting transformer accommodating space 4 is formed smaller, which enables the device to be more compact and lighter.

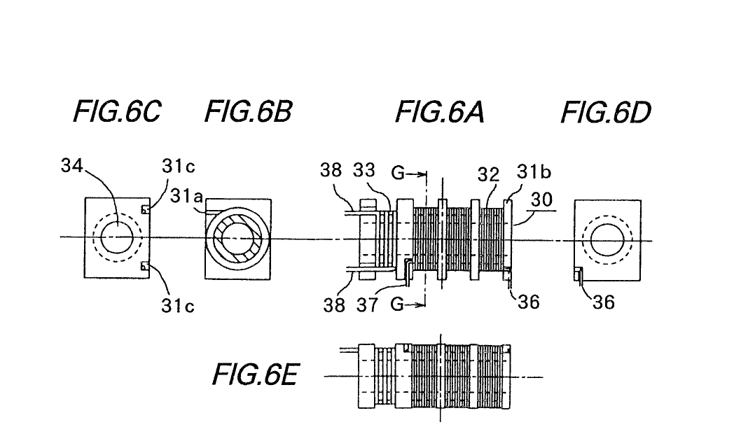

FIGS. 6A to 6E show the third coil arrangement of the starting transformer 30 having a straight bar shape with open magnetic path. In this arrangement the secondary coil is divided by section walls 31b. A section for the primary coil 33 is arranged at a lower voltage side section B (Sb) of the secondary coil 32. By employing this shape a starting transformer 30 is formed more compact and lighter than the embodiment 1.

As explained above, since the core-less structure according to the present invention has no electric current saturation and is not influenced by the ambient temperature, a smaller and lighter device is realized. As a result the following advantages are attained in producing the starting device for lamp lighting and its components. (a) Breakage of the device caused by vibrations and impacts etc. is prevented by arranging the starting transformer on the same central axis of the socket (except the third coil arrangement). (b) Life of the HID lamp is prolonged by employing divided winding around the bobbin of the transformer for increasing the distributed capacity. (c) The device can be fitted to every type of cars by attaining various connecting methods between the main body of the lamp lighting device and the starting device for lamp lighting.

In other words the following effects are attained in each component of the device.

(1) Core-less coil structure

No electric current saturation. In the transformer with core the inductance value is saturated from a certain electric current value.

Independent from the ambient temperature. In the transformer with core the inductance value at higher temperature, ca. 100° C., is saturated at lower electric current value. A magnetic substance having the Curie point is never used at higher temperature than the Curie point.

(2) The core-less starting transformer with the ring shape

Since this transformer has the closed magnetic path, magnetic flux leakage is kept at a low level. In other words, noise emission is suppressed. Which does not require shielding measures such as forming a metal enclosure etc. around the socket case. Since connections to high voltage electrodes are arranged at the hollow space of the ring center, a thinner device is obtained due to using the space effectively. A good insulation is attained by the molding material cast into the hollow space of the ring center. Since the center of the gravity of the starting transformer is located on the same axis as the center of the socket, vibrations are suppressed. A larger pulse wave pattern of the starting pulse is attained by increased inductance value due to elongated magnetic path.

(3) The core-less starting transformer with the horseshoe shape.

Providing a lighter starting transformer than the ring shaped one is possible.

(4) The core-less starting transformer with the straight bar shape.

Providing a lighter starting transformer than the horseshoe shaped one is possible. And a winding efficiency of the coil is improved.

(5) Divided coil winding around the bobbin of the starting transformer

The wider width of the outputting pulse is obtained by the divided winding resulting in the higher distribution capacity (several hundred times to several thousand times) among wires in the secondary coil. Which results in relieving a stress imposed on the lamp electrode, reducing wear of the electrode and further prolonging the lamp life.

(6) Connection between the main body of the device and lamp lighting device

By employing the harness equipped with the connector, coupler (connector) portion of the harness can be formed smaller then the direct coupler method. In some direct coupler methods, since a length of the harness equipped with the connector is adjustable to a desired length, it can be easily applied to different types of cars.

What is claimed is:

1. A starting device for discharge lamp comprising;
a socket equipped with a high voltage electrode and a grounding electrode for mounting said discharge lamp,
a bobbin, and
a starting transformer having a core-less structure equipped with a primary and a secondary coils wound around said bobbin; wherein
said starting transformer is formed as in a ring shape.

2. A starting device for discharge lamp comprising;
a socket equipped with a high voltage electrode and a grounding electrode for mounting said discharge lamp,
a bobbin, and
a starting transformer having a core-less structure equipped with a primary and secondary coils wound around said bobbin; wherein
said starting transformer is formed in a horseshoe shape.

3. A starting device for discharge lamp comprising;
a socket equipped with a high voltage electrode and a grounding electrode for mounting said discharge lamp,
a bobbin, and
a starting transformer having a core-less structure equipped with a primary and secondary coils wound around said bobbin; wherein
said starting transformer is formed in a straight bar shape for being arranged laterally.

4. The starting device for discharge lamp according to claim 1 or claim 2 wherein;
said core-less structure with 0 to 10 mm in diameter formed in a round shape,
coil winding portion of said bobbin is formed in a divided round shape for divided winding and arranged on the same axis of said socket, and
further a leading wire from said secondary coil is electrically connected to a high voltage electrode of said socket after said leading wire is led through the center of said socket.

5. The starting device for discharge lamp according to either one of claim 1 to claim 4 wherein said device is equipped with a harness with connector.

6. The starting device for discharge lamp according to either one of claim 1 to claim 4 wherein said device is equipped with a direct coupler.
